(19) United States
(12) Patent Application Publication
(10) Pub. No.: US 2026/0258692 A1
(43) Pub. Date: Sep. 3, 2026

(54) TWO-PART POST

(71) Applicant: Eucatex Indústria e Comércio Ltda, São Paulo SP (BR)

(72) Inventor: Flavio Maluf, São Paulo SP (BR)

(21) Appl. No.: 19/137,544

(22) PCT Filed: Feb. 15, 2023
(86) PCT No.: PCT/BR2023/050056

§ 371 Date: Jun. 10, 2025

(30) Foreign Application Priority Data
Dec. 27, 2022 (BR) 1020220267545

(51) Int. Cl. E06B 1/08

(52) U.S. Cl. CPC E06B 1/08

(57) ABSTRACT

This invention relates to a two-part jamb, more specifically, this invention relates to a two-part jamb made of wood panel and/or plastic wood composite. The two-part jamb (1) comprising a first body (10) and a second body (20) that can be associated with each other, in which the first body (10) comprises a protrusion (11) and the second body (20) comprises a groove (21) and a recess (22) adjacent to each other, so that the association between the first body (10) and the second body (20) configures an encasement between the protrusion (11) and the groove (21) concomitantly with the configuration of an opening (30, 31) in the two-part jamb (1).

### CROSS REFERENCE TO RELATED APPLICATIONS

This application is a National Stage Application, filed under 35 U.S.C. § 371, of International Application No. PCT/BR2023/050056, filed Feb. 15, 2023, which international application claims priority to and the benefit of Brazilian Application No. 102022026754-5, filed Dec. 27, 2022; the contents of both of which are hereby incorporated by reference in their entirety.

### BACKGROUND

### Technical Field

This invention relates to a two-part jamb, more specifically, this invention relates to a two-part jamb made of wood panel and/or plastic wood composite.

### Description of Related Art

As is well known, the installation of doors in buildings requires jambs to secure them to the wall. The jamb and door union, among other elements, also includes an associated trim on both sides of the wall.

The jamb is the element where the door leaf is fixed, being installed on the inside of the wall to support the leaf and allow the door to be opened and closed safely and conveniently. This item is indispensable for the operation of the opening system, as it is on the jamb where the locks and door latches are fixed.

The jamb also serves to seal any gaps between the door and the wall, thus preventing wind currents and the entry of dust and insects into the house.

The trims are pieces fixed to the ends of the jamb and serve the purpose of finishing the door, in order to cover the outside of the wall, like a frame. The main purpose of this accessory is to ensure a flawless/exemplary/commendable finish, as well as to serve as protection for the side of the wall.

Developments in this technical field over the years have presented various solutions for jambs, such as adjustable jambs, unilaterally or bilaterally, which provide a greater margin of adjustment for the assembly of the jamb next to walls of different thicknesses.

The state of the art has also presented solutions with regard to two-part jambs, in which, even when part of the jamb is already fixed to the wall and to each of the trims, it is possible to adjust the assembly of the jamb in relation to the thickness of the door.

Document ES226333 describes, for example, a two-part jamb in which, after completing the assembly of the trims with the base part of the frame fixed to the wall, if it is decided to install a door with a different thickness from the initial assembly, it is sufficient to change/replace the dimensions of the upper part of the frame according to the thickness of the door. It is not necessary to remove the trim parts or the base part of the jamb, as the only part that is discarded is the top part of the jamb.

However, these state-of-the-art solutions are complex and costly, as the total manufacturing time is high due to the number of necessary processes, which require various resources and do not benefit from this total quantity, since the final product does not utilize the entire initial strip, resulting in non-reusable waste.

In addition, and of paramount importance, these state-of-the-art solutions are obsolete in relation to the advances in civil construction.

Currently, civil construction is efficient through standardized products and projects in order to meet regulations established by competent bodies, considering the requirements of safety, habitability, and sustainability.

In fact, the technologies and engineering processes applied in the manufacture of doors and wood panel components, such as drying and reconstitution of the raw material through the selection and gluing of the parts, have currently evolved in terms of the product's resistance, performance, and durability.

For example, doors and their components, such as the jamb, must meet general and specific mechanical stresses, as well as hygroscopic variations and resistance to moisture, with reference to the NBR 15930-2 standard.

In addition, it must be considered that the use of panels made from various types of materials contributes to the enhancement of the quality of doors and their components, as the raw material has specific characteristics that provide acoustic and thermal comfort to the environment. Wood panels, for example, are considered a 100% renewable raw material in civil construction.

In this context, the state of the art is silent on these advantages and benefits. There is a gap regarding technologies aimed at jambs obtained from a panel that meet the advances in civil construction, in an efficient and less costly way, considering the requirements of safety, habitability, and sustainability.

### BRIEF SUMMARY

The purpose of this invention is to provide a two-part jamb obtained from a wooden panel and/or plastic wood composite that addresses the drawbacks of the current state of the art. The present invention also aims to provide a two-part jamb obtained with an improved configuration.

The present invention relates to a two-part jamb that comprises a first body and a second body that can be associated with each other, with the first body comprising a protrusion and the second body comprising a groove and a recess adjacent to each other, so that the association between the first body and the second body forms an encasement between the protrusion and the groove, simultaneously configuring an opening in the two-part jamb.

In a possible embodiment, the association between the first body and the second body of the two-part jamb forms a first opening in the two-part jamb between the first body and the recess of the second body.

In another possible embodiment, the second body of the two-part jamb comprises a slot positioned opposite the first opening.

In another possible embodiment, the slot of the second body and the first opening of the two-part jamb have the same thickness.

In another possible embodiment, the first opening and the slot of the second body can each be associated with a jamb trim.

In another possible embodiment, the first body comprises a recess adjacent to the protrusion, so that the association between the first body and the second body forms a second opening in the two-part jamb between the second body and the recess of the first body.

In another possible embodiment, the second opening of the two-part jamb is positioned opposite the first opening.

In another possible embodiment, the second opening of the two-part jamb can be associated with a sealing element.

In another possible embodiment, the first body of the two-part jamb is associable with a door and the second body of the two-part jamb is associable with a doorway in a wall.

In all possible embodiments, the coating of the jamb can be alternated with different decorative patterns between the body and the rod on the same jamb, in order to establish a consistent design in relation to the pattern of each environment (internal and external to the door).

### BRIEF DESCRIPTION OF THE FIGURES

The present invention will be described in more detail below based on an exemplary execution represented in the drawings. The figures show:

FIG. 1—is a top view, in section, of the two-part jamb that is the object of this invention.

FIG. 2—is a top-down, sectional view of the object shown in FIG. 1.

FIG. 3—is a top-down, sectional view of the object shown in FIG. 1.

FIG. 4—is a top-down, sectional view of the object shown in FIG. 1.

FIG. 5—is a perspective view of an application of the two-part jamb, the object of the present invention.

FIG. 6—is a perspective view of another application of the two-part jamb, the object of the present invention.

FIG. 7—is a perspective view of another application of the two-part jamb, the object of the present invention.

FIG. 8—is a perspective view of an application of a state-of-the-art one-piece jamb.

### DETAILED DESCRIPTION OF VARIOUS EMBODIMENTS

First, it should be noted that the term “preferred” as used herein should not be understood as “imperative” or “mandatory”. The term “preferred” is intended to characterize a particularly efficient embodiment of the invention among the multiple possible ones, with the scope of the invention being limited solely by its characteristics that are absolutely essential for achieving the proposed technical effects.

For the purposes of understanding this invention, the term “means” and “elements” should be understood as any mechanism, part, device, or arrangement of elements that performs the function for which a specific result is expected within the context of this invention.

Nevertheless, in the context of the invention, a wooden panel should be understood as a material such as MDF, MDP, solid wood; and a wood plastic composite panel should be understood as a WPC type material—Wood-plastic composites, composed of wood fiber/wood sawdust and thermoplastic(s), which may include PE, PP, PVC, etc. The raw material may be 100% recycled or not, depending on the source,

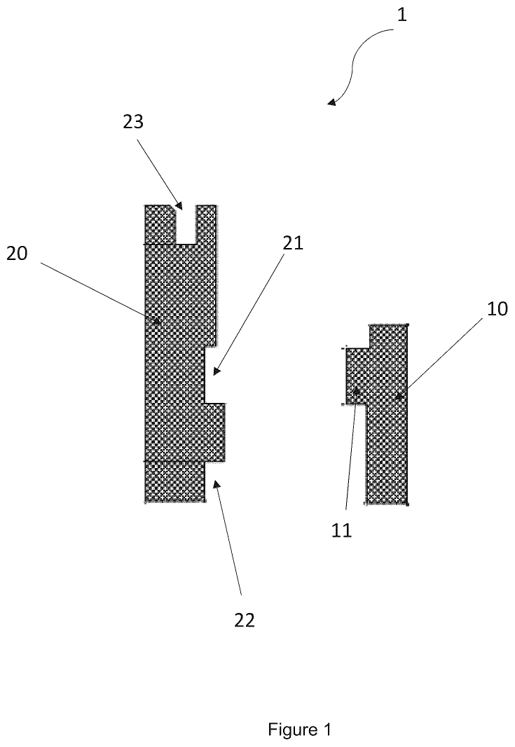

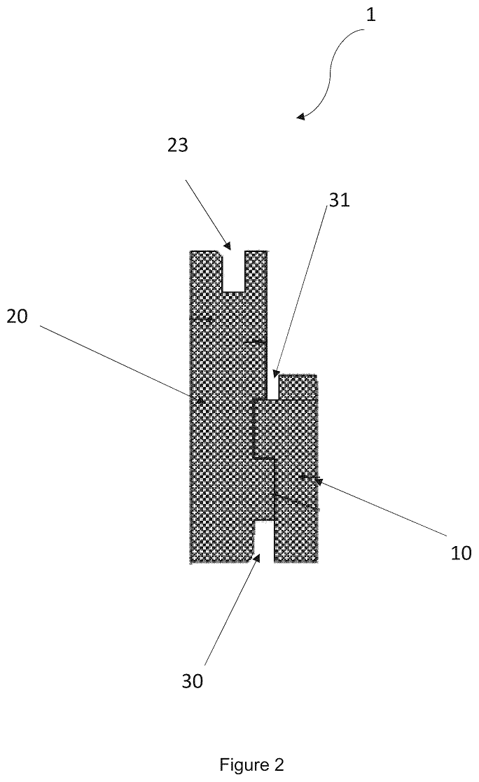

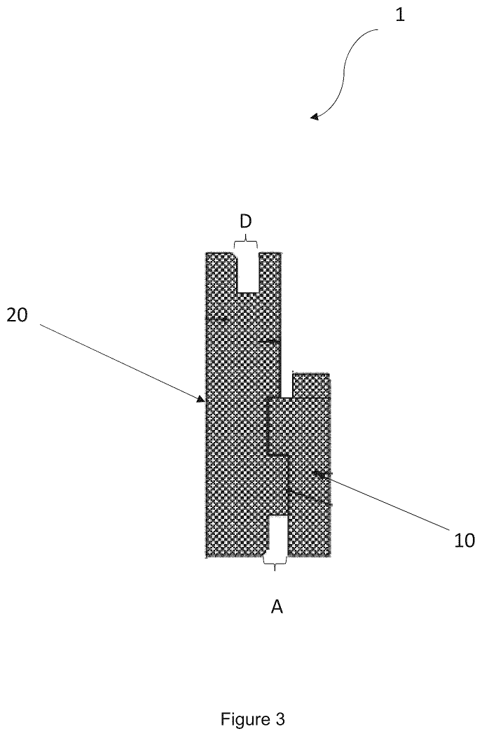

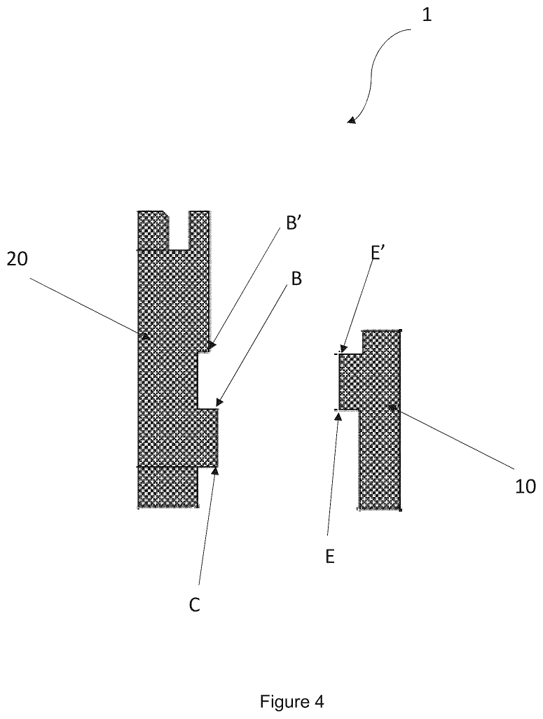

As observed in FIGS. 1, 2, 3, and 4, the present invention relates to a two-part jamb comprising a first body 10 associated with a second body 20, said association of the first and second bodies 10, 20 occurring by encasing the protrusion 11 of the first body 10 into the groove 21 of the second body 20.

The first and second bodies 10, 20 have a substantially rectangular shape, with the protrusion 11 and the groove 21 each positioned on one of the longitudinal surfaces of the first and second bodies 10, 20, which are facing each other when the two-part jamb 1 is encased.

The longitudinal surfaces of the first body 10 have a shorter length compared to the longitudinal surfaces of the second body 20, so that the first body 10 functions to limit the movement of a door, and the second body 20 functions to fix itself in the doorway of a wall.

The second body 20 comprises on the same longitudinal surface of the groove 21 a recess 22 that defines a first opening 30 when the first body 10 is associated with the second body 20, said first opening 30 being associable with a jamb trim 40.

Thus, in an advantageous way, the two-part jamb 1 of the present invention differs from the single-body and two-part jambs of the prior art by presenting an improved configuration with regard to the manufacture and assembly of the jamb.

It should be noted that the state-of-the-art solutions feature a jamb comprising two slots/openings at the base of the jamb for association with the jamb trims.

In contrast, as observed in FIGS. 1, 2, 3, and 4, in the present invention, the recess 22 extends longitudinally with a smaller thickness compared to the total thickness of the second body 20, below the groove 21, and up to one end of the second body 20.

This reduction in thickness constitutes the formation of the first opening 31 upon the association of the first and second bodies 10, 20. Naturally, the depth of the groove 21, as well as the height of the protrusion 11, have the same dimension as the reduction in thickness of the recess 22.

At the other end of the second body, on the transverse surface and above groove 21, there is a slot 23 with the same thickness as the recess 22, said slot 23 being associable with a jamb trim 40.

Naturally, the association of the first body 10 with the second body 20 occurs in a rigidly fixed manner through the application of a fastening means, such as adhesive, coating, screws, pins, etc. Preferably, the association of the first and second bodies 10, 20 of the two-part jamb occurs through the application of glue, more preferably, EVA D3 glue.

Thus, the two-part jamb 1 of the present invention can advantageously accommodate a plurality of project dimensions and configurations, provided that the characteristics described above are met.

Unlike state-of-the-art solutions, the benefits of the present invention result from an improved configuration in which the two-part jamb 1 comprises an opening 30 with a thickness dimension (A) corresponding to the same depth dimension (B) of groove 21, thickness (C) of recess 22, and thickness (D) of slot 23 of the second body 20, as well as the same height dimension (E) of protrusion 11 of the first body 10.

In other words, advantageously, the correspondence of these dimensions A=B=C=D=E reflects the thickness of the jamb trim 40, commonly known as the encasement space of the molding (jamb trim), so that the object of the present invention is applicable to projects of any dimensions.

However, the improved configuration of the two-part jamb of the present invention may also allow for the association with adjustable jamb trims, depending on the longitudinal position of the protrusion 11 in the first body 10 and the longitudinal position of the groove 21 in the second body, as well as the longitudinal length of the protrusion 11 and the groove 21.

Thus, advantageously, the combination of variations of these characteristics allows for a variation in the longitudinal length of the recess 22 and the opening 30.

In continuity, in a possible disclosure of the invention, the association between the first body 10 and the second body 20 configures a second opening 31, by means of a recess 12 in the first body 10 adjacent to the protrusion 11 of the first body 10.

Said second opening 31 can be associated with a sealing element and/or shock absorbing rubber, in such a way that the improved configuration of the jamb allows the second opening to correspond to any thickness values of the rubber base to be chosen, meaning that the object of the present invention is applicable to projects of any dimensions.

In this disclosure, the protrusion 11 of the first body 10 comprises a second height dimension (E′) different from the first height dimension (E), meaning the side walls of the protrusion 11 of the first body 10 exhibit a difference in height.

Similarly, the groove 21 of the second body 20 comprises a second depth dimension (B′) different from the first depth dimension (B), i.e., the side walls of groove 21 of the second body 20 exhibit a difference in height.

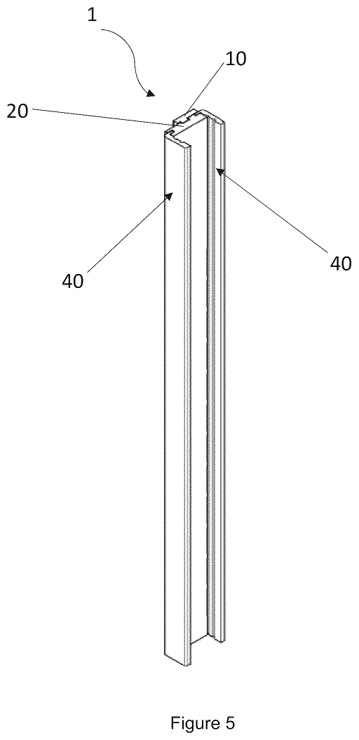

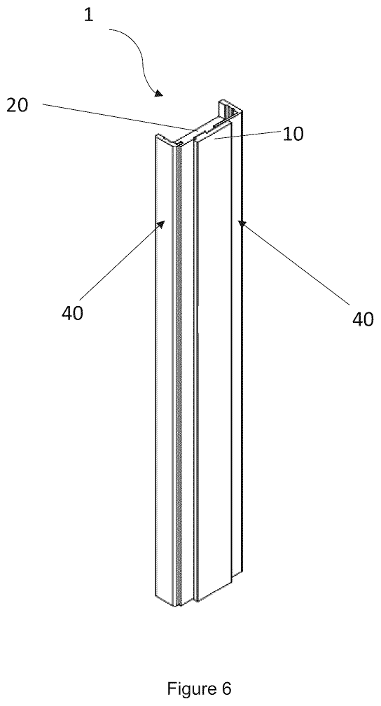

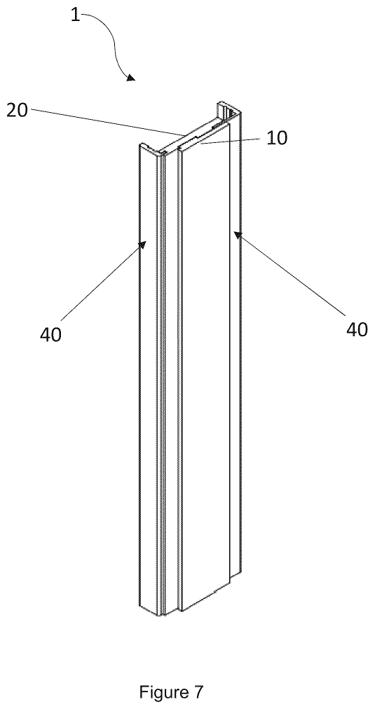

Of the possible embodiments of the invention, the two-part jamb is applicable, for example, to dimensions of 75 mm, 90 mm, and 150 mm in length, as shown respectively in FIGS. 5, 6, and 7.

As such, another advantage of the two-part jamb 1 of the present invention, also linked to the improved configuration of the first and second bodies 10, 20, refers to the utilization of the panel during the manufacturing/machining of the parts, that is, the first and second bodies 10, 20.

Among the possible disclosures of the invention, for panels comprising around 4 m² it is possible to obtain:
for 75 mm jambs, around thirty-six pieces of first body 10, with 88% utilization of the panel; and twenty-two pieces of second body 20, with 89% utilization of the panel;
for 90 mm jambs, around twenty-eight pieces of first body 10, with 91% panel utilization; and 18 pieces of second body 20, with 88% panel utilization; and
for 150 mm jambs, around fourteen pieces of first body 10, with 91% panel utilization; and ten pieces of second body 20, with 81% panel utilization.

The state of the art is completely silent regarding the possible disclosures and advantages of the present invention.

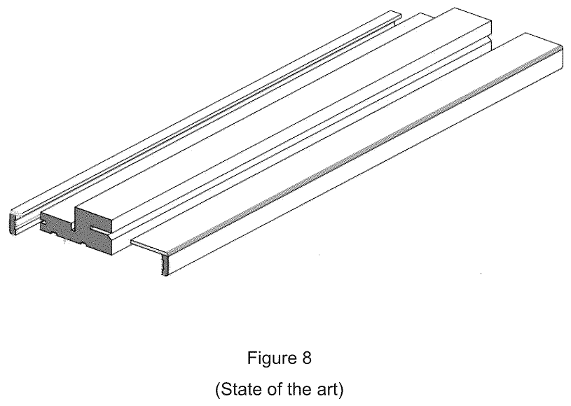

However, in order to make the benefits and advantages of the present invention clear and crystal clear, the values found for the comparison between 3 disclosures (75 mm, 90 mm, and 150 mm) of the two-part jamb of the present invention and a one-piece jamb of the prior art are described below (FIG. 8).

The values found refer to “Utilization of panels” and “Consumption of glue to join the panels”.

### 75 mm Jambs

With regard to the utilization of panels for one-piece jambs, a utilization of 71% of the panel was identified, meaning a loss of 29%.

In contrast, advantageously, for the two-part jamb of the present invention, a utilization of 88% of the panel was identified, i.e., a loss of 12%.

With regard to the consumption of glue to join the panels for single-piece jambs, it was identified that glue is applied over an area of 4.070 m² to obtain 22 unique pieces.

In constant, advantageously, for the two-part jamb of the present invention, it was identified that glue is applied in an area of 0.686 m² to join 22 sets, that is, to join the first body 10 and the second body 20 of the two-part jamb.

As a result, an 83.15% reduction in glue consumption is highlighted in the disclosure of this invention for 75 mm jambs to achieve the same amount of finished parts compared to single-piece jambs.

### 90 mm Jambs

With regard to the utilization of panels for one-piece jambs, a utilization of 73% of the panel was identified, meaning a loss of 27%.

In contrast, advantageously, for the two-part jamb of the present invention, a utilization of 89% of the panel was identified, i.e., a loss of 11%.

With regard to the consumption of glue to join the panels for single-piece jambs, it was identified that glue is applied over an area of 4.070 m² to obtain 18 unique pieces.

In a constant and advantageous manner, for the two-part jamb of the present invention, it was identified that glue is applied over an area of 0.929 m² to join 18 sets, that is, to join the first body 10 and the second body 20 of the two-part jamb.

As a result, a 77.18% reduction in glue consumption is highlighted in the disclosure of this invention for 90 mm jambs to achieve the same amount of finished parts compared to single-piece jambs.

### 150 mm Jambs

With regard to the utilization of panels for one-piece jambs, a utilization of 73% of the panel was identified, meaning a loss of 27%.

In contrast, advantageously, for the two-part jamb of the present invention, a utilization of 86% of the panel was identified, i.e., a loss of 14%.

With regard to the consumption of glue to join the panels for one-piece jambs, it was identified that glue is applied over an area of 4.070 m² to obtain 10 unique pieces.

In a consistent and advantageous manner, for the two-part jamb of the present invention, it was identified that glue is applied over an area of 0.849 m² to join 10 sets, that is, to join the first body 10 and the second body 20 of the two-part jamb.

As a result, a 79.13% reduction in glue consumption is highlighted in the disclosure of this invention for 150 mm jambs to achieve the same amount of finished parts compared to single-piece jambs.

As shown above, the present invention differs from the state of the art by providing a jamb that meets the advances in civil construction in an efficient and less costly manner, considering the requirements of safety, habitability, and sustainability.

The two-part jamb of the present invention advantageously features a reduced total manufacturing time compared to one-piece jambs, requiring simplified resources and better utilization of the material.

Having described a preferred embodiment, it should be understood that the scope of the present invention encompasses other possible variations, being limited only by the content of the accompanying claims, possible equivalents included therein.

1. A two-part jamb (1) comprising:
a first body (10) and a second body (20) that can be associated with each other,
wherein the first body (10) comprises a protrusion (11) and the second body (20) comprises a groove (21) and a recess (22) adjacent to each other, so that the association between the first body (10) and the second body (20) forms an encasement between the protrusion (11) and the groove (21) while simultaneously configuring an opening (30, 31) in the two-part jamb (1).

2. The two-part jamb (1) according to claim 1, wherein the association between the first body (10) and the second body (20) forms a first opening (30) in the two-part jamb (1) between the first body (10) and the recess (22) of the second body (20).

3. The two-part jamb (1) according to claim 1, wherein the second body (20) comprises a slot (23) positioned opposite the first opening (30).

4. The two-part jamb (1) according to claim 1, wherein the slot (23) and the first opening (30) comprise the same thickness.

5. The two-part jamb (1) according to claim 1, wherein the first opening (30) and the slot (23) can each be associated with a jamb trim (40).

6. The two-part jamb (1) according to claim 1, wherein the first body (10) comprises a recess (12) adjacent to the protrusion (11), so that the association between the first body (10) and the second body (20) forms a second opening (31) in the two-part jamb (1) between the second body (20) and the recess (12) of the first body (10).

7. The two-part jamb (1) according to claim 1, wherein the second opening (31) is positioned opposite the first opening (30).

8. The two-part jamb (1) according to claim 1, wherein the second opening (31) can be associated with a sealing element.

9. The two-part jamb (1) according to claim 1, wherein the first body (10) is associable with a door and the second body (20) is associable with a doorway of a wall.

10. The two-part jamb (1) according to claim 1, wherein it is composed of at least one of MDF, MDP, solid wood, or plastic wood (WPC) type wood panel.

11. The two-part jamb (1) according to claim 2, wherein the second body (20) comprises a slot (23) positioned opposite the first opening (30).

12. The two-part jamb (1) according to claim 2, wherein the slot (23) and the first opening (30) comprise the same thickness.

13. The two-part jamb (1) according to claim 2, wherein the first opening (30) and the slot (23) can each be associated with a jamb trim (40).

14. The two-part jamb (1) according to claim 2, wherein the first body (10) comprises a recess (12) adjacent to the protrusion (11), so that the association between the first body (10) and the second body (20) forms a second opening (31) in the two-part jamb (1) between the second body (20) and the recess (12) of the first body (10).

15. The two-part jamb (1) according to claim 2, wherein the second opening (31) is positioned opposite the first opening (30).

16. The two-part jamb (1) according to claim 2, wherein the second opening (31) can be associated with a sealing element.

17. The two-part jamb (1) according to claim 2, wherein the first body (10) is associable with a door and the second body (20) is associable with a doorway of a wall.

18. The two-part jamb (1) according to claim 2, wherein it is composed of at least one of MDF, MDP, solid wood, or plastic wood (WPC) type wood panel.
